(19) United States
(12) Patent Application Publication
(10) Pub. No.: US 2008/0116266 A1
(43) Pub. Date: May 22, 2008

(54) METHOD FOR VALUING CUSTOMERS AND CUSTOMER RELATIONSHIPS

(76) Inventor: SUDHEE NAGABHUSHAN SUBRAHMANYA, Austin, TX (US)

Correspondence Address: IBM CORP (YA);C/O YEE & ASSOCIATES PC, P.O. BOX 802333, DALLAS, TX, 75380, US

(21) Appl. No.: 11/552,844

(22) Filed: Oct. 25, 2006

(51) Int. Cl. G06K 15/00; G06F 9/44

(52) U.S. Cl. 235/383; 705/7

(57) ABSTRACT

A computer implemented method, a computer program product, and a data processing system are provided for valuing a customer or a customer relationship. Black-Scholes model for determining option value of stocks is adapted for use in valuing customers and customer relationships. Variables of Black-Scholes model are mapped to parameters relating to customers and customer relationships. A customer variance is determined for the customer relationship based on data about several customers. The value of a customer or a customer relationship is then computed by applying the customer variance and the mapped parameters to the Black-Scholes model. The computed value of the customer, or the customer relationship, is used in the decision making process to determine, among other things, which products and services to offer for sale to a customer, what the offering price to the customer should be, how much expenditures are to be allowed for the customer relationship, whether the customer relationship remains viable, perform on-going dynamic evaluation of the customer relationship, allocate marketing and advertising budgets, and suitability of business activities with respect to customers and customer relationships.

### BACKGROUND OF THE INVENTION

1. Field of the Invention

The present invention relates generally to an improved data processing system, and in particular, to a computer implemented method, apparatus, and computer usable program code for customer management. Still more particularly, the present invention relates to a computer implemented method, apparatus, and computer usable program code for valuing a customer relationship using Black-Scholes model.

2. Description of the Related Art

Companies performing projects for its customers have a need for determining, as best they can, whether a particular project should be accepted. Because performing a project requires investment of company resources and capital, the more accurate this determination, the less the risk is to the company. Risk to the company can be quantified in various forms. A project that consumes more resources than it pays is a risk. A project that was initially profitable may subsequently become a risk for loss when the project overruns the budget and time. A project may be profitable, but still a risk if the size of investment required is too large compared to the size of the total dealings with the customer. Similarly, many other factors are present to be considered when determining the risks associated with a project.

A determination of risk associated with a project also translates to the determination of the value of the customer and the project in question. A company may accept higher risks for higher value customers, and consequently for higher value projects.

Relationship with a customer also has characteristics similar to those of a project. Resources are required to build and maintain customer relationships that are profitable. Similar to projects, customer relationships can become risks for loss to a company over the course of time and dealings.

A determination of risk is not a static determination, but an ongoing process for the life of the project. As a project progresses, the risks associated with the project change, as does the value of the project. Changes in the marketplace for similar products and services as used in the project, and change in the cost of those products and services are some examples that illustrate the variable nature of the value of a project.

Financial investment industry uses a Real Options methodology for determining the risks associated with the trading of a security instrument, such as in capital investment projects. Computation in the Real Options methodology relies upon a variety of financial computation models, including the Black-Scholes model for determining the value of a security and its derivatives based upon the trading of the associated security.

### SUMMARY OF THE INVENTION

The illustrative embodiments provide a computer implemented method, an apparatus, and a computer usable program product for valuing a customer relationship. A customer variance is determined for the customer relationship based on data about several customers. The value of a customer relationship is determined by applying the customer variance, a present value of estimated revenues from the customer, an expenditure in acquiring an order from the customer, a length of time during which a purchase decision for the order may be deferred by the customer, and a time-value of money to a Black-Scholes model. The value of the customer relationship is used for managing the customer.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a data processing environment in which illustrative embodiments may be implemented;

FIG. 2 is a block diagram of a system for valuing a customer relationship in accordance with an illustrative embodiment;

FIG. 3 is a flowchart depicting the steps of the process for valuing a customer relationship in accordance with an illustrative embodiment;

FIG. 4 is a block diagram of exemplary customer data in accordance with an illustrative embodiment;

FIG. 5 is two graphical representations and an equation representation of variance in accordance with an illustrative embodiment;

FIG. 6 is a table of mapping of variables in accordance with an illustrative embodiment; and

FIG. 7 is a sample value report in accordance with an illustrative embodiment.

### DETAILED DESCRIPTION OF THE PREFERRED EMBODIMENT

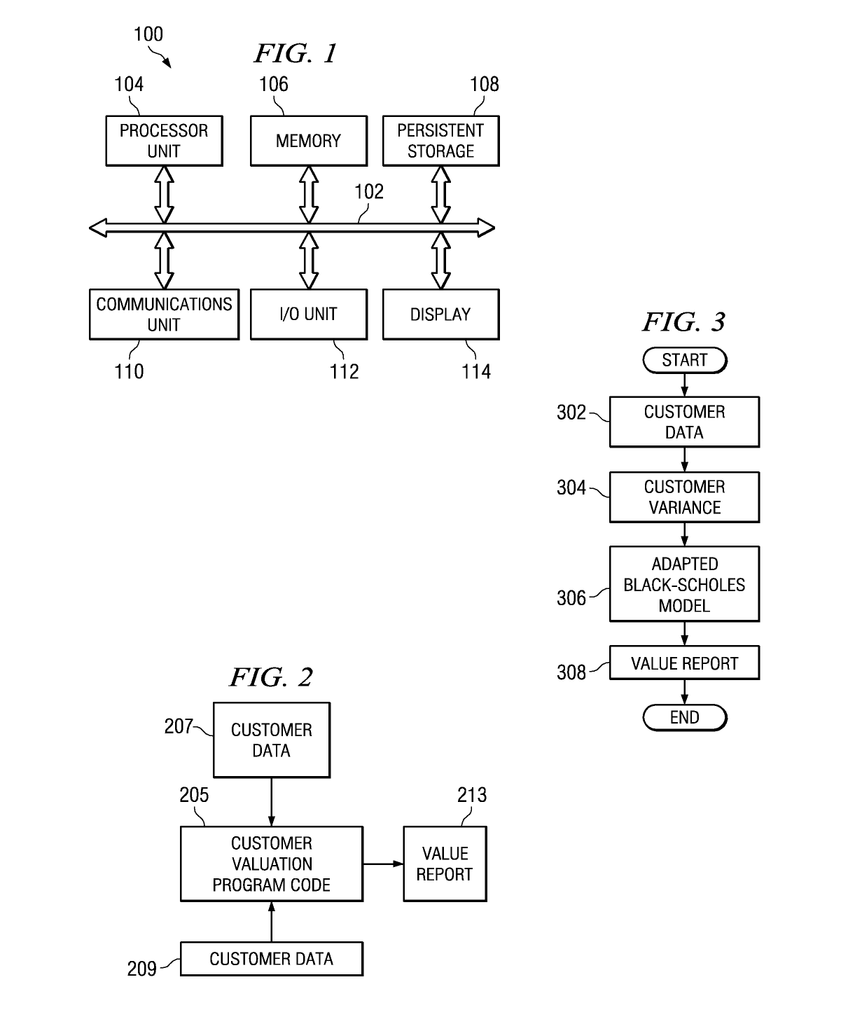

With reference now to the figures and in particular with reference to FIG. 1, an exemplary diagram of a data processing environment is provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Turning now to FIG. 1, a diagram of a design system is depicted in accordance with an illustrative embodiment. In this illustrative example, data processing system 100 includes communications fabric 102, provides communications between processor unit 104, memory 106, persistent storage 108, communications unit 110, I/O unit 112, and display 114.

Processor unit 104 serves to execute instructions for software that may be loaded into memory 106. Processor unit 104 may be a set of one or more processors or may be a multi-processor core, depending on the particular implementation. Further processor unit 106 may be implemented using one or more heterogeneous processor systems in which a main processor is present with secondary processors on a single chip. Memory 106, in these examples, may be, for example, a random access memory. Persistent storage 108 may take various forms depending on the particular implementation. For example, persistent storage 108 may be, for example, a hard drive, a flash memory, a rewritable optical disk, a rewritable magnetic tape, or some combination of the above.

Communications unit 110, in these examples, provides for communications with other data processing systems or devices. In these examples, communications unit 110 is a network interface card. I/O unit 112 allows for input and output of data with other devices that may be connected to data processing system 100. For example, I/O unit 112 may provide a connection for user input though a keyboard and mouse. Further, I/O unit 112 may send output to a printer. Display 114 provides a mechanism to display information to a user.

Instructions for the operating system, the object-oriented programming system, and applications or programs are located on persistent storage 108. These instructions and may be loaded into memory 106 for execution by processor unit 104. The processes of the different embodiments may be performed by processor unit 104 using computer implemented instructions, which may be located in a memory, such as memory 106.

FIG. 1 is intended as an example, and not as an architectural limitation for different embodiments. The hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 106 or a cache such as found in north bridge and memory controller hub. A processing unit may include one or more processors or CPUs. The depicted examples in FIG. 1 and above-described examples are not meant to imply architectural limitations. For example, data processing system 100 also may be a tablet computer, laptop computer, or telephone device in addition to taking the form of a PDA.

The value of a project is an indicator of whether the project is profitable. A project is an investment of resources into efforts such as marketing, advertising, sales, and development of customer base by a company.

The illustrative embodiments recognize that a customer's value to a company is an indicator of how profitable the customer is, or has been in the past, or will be in the future. Value of a customer also indicates whether the company should continue to engage in business with the customer, reduce or expand the business relationship, or change the method of business and product offering.

Customer relationships can be viewed as projects in themselves. A customer relationship is formed when a company deals with a customer. A customer relationship project is, therefore, a project about managing one or more customer relationships.

The relationship between the customer and the company consumes resources, such as financial resources to market products and services to the customer, and human resources for customer service. The value of a customer relationship can indicate whether the relationship with the customer is consuming more resources than it should, whether the relationship with the customer remains viable, and whether to engage in the specific kind of projects with that customer or other similar customers in the future.

A variety of factors contributes to the valuation of customers and customer relationship projects, including customer relationship management (CRM) projects. Customer relationship management (CRM) project is a type of project that helps manage customer relationships. Customer relationship projects can involve specific technologies such as PeopleSoft®, which is a commercially available customer relationship management application. Such factors can be circumstantial and can vary depending on external factors. The valuation and the underlying investments are not always easily determined.

Measurements pertaining to customer relationship are customer relationship measurements. These measurements include determining risk and value of the customers and customer relationship projects. As an example, a customer relationship is presently measured using customer spending history, response rates, booking rates, number of transactions, investment in technology, and several other metrics. However, illustrative embodiments recognize that the value of the investment in the relationship with the customer is not considered in this measurement.

Similarly, whether the customer has a protracted decision making process, or a great degree of flexibility in deciding whether to buy or not to buy, or the amount of profits from the customer, all have a bearing on the value of the relationship with that customer. Yet, as illustrative embodiments further recognize, these factors are also not accounted for in the present measurement methods.

Real Options methodology is a financial methodology used for computing the risk, and conversely the value, associated with capital investment projects. Computation in the Real Options methodology relies in part upon the Black-Scholes model for determining the value of a security and its derivatives based upon the trading of the associated security. The illustrative embodiments provide a method, apparatus, and computer usable program code for adapting Black-Scholes model to perform customer relationship measurements. The adapted Black-Scholes model can then be used in Real Options computations for computing risks and values of customer relationships.

Black-Scholes model is a model for estimating the value of a stock option, developed by Fischer Black and Myron Scholes in 1973. They built on earlier research by Edward Thorpe, Paul Samuelson, and Robert C. Merton. Merton and Scholes received the 1997 Nobel Prize in Economics for this and other related work.

Black-Scholes model is in the form of a proof that the risk-free interest rate is the correct discount factor, without requiring assumptions regarding investor's risk preferences.

The model:

C = SN(d₁) − Ke^{(-rt)}N(d₂)
C = Theoretical call premium
S = Current stock price
t = time until option expiration
K = option striking price
r = risk free interest rate
N = Cumulative standard normal distribution
e = exponential term (2.7183)
d₁ = (ln(S/K) + (r + s²/2)t)/s√t
d₂ = d1 − s√t
s = standard deviation of stock returns
ln = natural logarithm

The model consists of two parts. The first part, SN(d₁), derives the expected benefit from acquiring a stock outright. This is found by multiplying stock price [S] by the change in the call premium with respect to a change in the underlying stock price [N(d₁)]. The second part of the model, Ke^{(-rt)}N(d₂), gives the present value of paying the exercise price on the expiration day. The fair market value of the call option is then calculated by taking the difference between these two parts. All terms used in the equation of the Black-Scholes model described above carry the definitions commonly understood in the financial industry.

In adapting Black-Scholes model for valuation of customers and customer relationships, illustrative embodiments recognize that this method of valuing call options can be modified for valuing customers and customer relationship projects. Furthermore, illustrative embodiments recognize that such valuation can also be applied to valuation of the existing customer base for a given company at a given time. Such valuations are important tools for decision making with respect to marketing efforts, marketing budgets, customer development initiatives, and analysis of the company's competitiveness.

With reference now to FIG. 2, a block diagram of a system for valuing a customer relationship is depicted in accordance with an illustrative embodiment. The system for valuing a customer relationship can be implemented using data processing system 100 in FIG. 1. A processor, such as processor 104 in FIG. 1, executes instructions contained in customer valuation program code 205.

Customer valuation program code 205 is loaded in memory, such as memory 106 in FIG. 1. Customer valuation program code 205 utilizes customer data 207 that can reside in persistent storage, such as persistent storage 108 in FIG. 1. Customer data 207 includes information about transactions with one or more customers. For example, purchase history of each customer including value of each purchase, length of engagement, and time-period of purchase decision, could be included in customer data 207. These types of customer data are listed here only as exemplary, and are not intended to be limiting on the illustrative embodiments. Other types of customer data usable in the illustrative embodiments will become apparent to those of ordinary skill in the art from this disclosure.

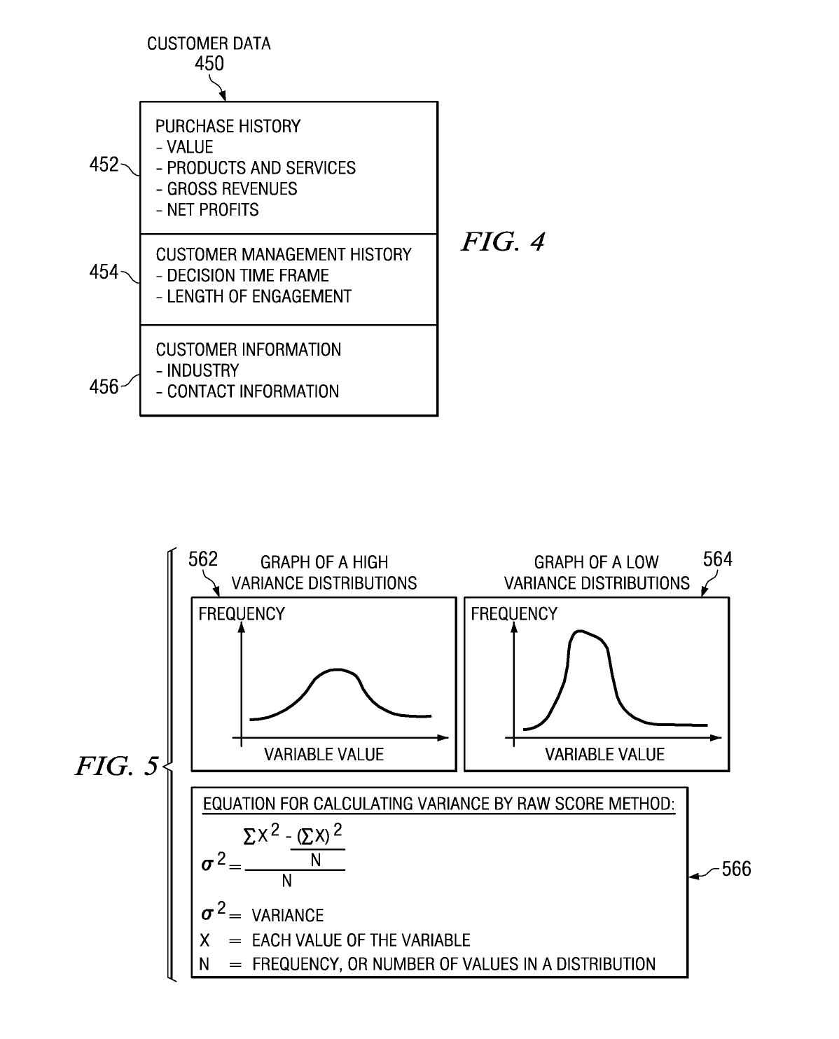

Furthermore, the customer data used by customer valuation program code 205 can come from more than one source. External systems may also provide customer data 209 for use in the customer valuation program code. Several such external systems can exist and provide customer data. FIG. 4 depicts exemplary contents of customer data 207 and 209 in detail.

Customer valuation program code 205 produces value report 213, which includes the risk and value information pertaining to one or more customers in question, determined as described above. FIG. 5 depicts an exemplary value report generated using the illustrative embodiments. Value report 213 can take many forms, including being a number value which can be input into a customer relationship management system. A customer relationship management system is a customer relationship management software application running on a data processing system. The customer relationship management system can then produce reports, directives for future actions, and recommendations for changes with respect to a customer relationship management project, using the value report.

With reference now to FIG. 3, a flowchart depicting the steps of the process for valuing a customer relationship is depicted in accordance with an illustrative embodiment. The process of FIG. 3 can be implemented in customer valuation program code 205 in FIG. 2.

The process begins by receiving customer data, such as customer data 207 and 209 in FIG. 2, (step 302). FIG. 4 depicts the details of exemplary customer data. Based on the customer data, the process computes customer variance (step 304). Customer variance is a measure of customer volatility, uncertainty of the customer, or uncertainty of the relationship with the customer. For example, if a customer can decide to buy a service, or not buy at all, the variance is 100 percent or 1, between buying and not buying decision. On the other hand, if the customer's decision flexibility is less than as described above, the customer variance is a smaller fraction. FIG. 5 depicts graphical illustrations of high and low variance distributions, and an equation for computing variance.

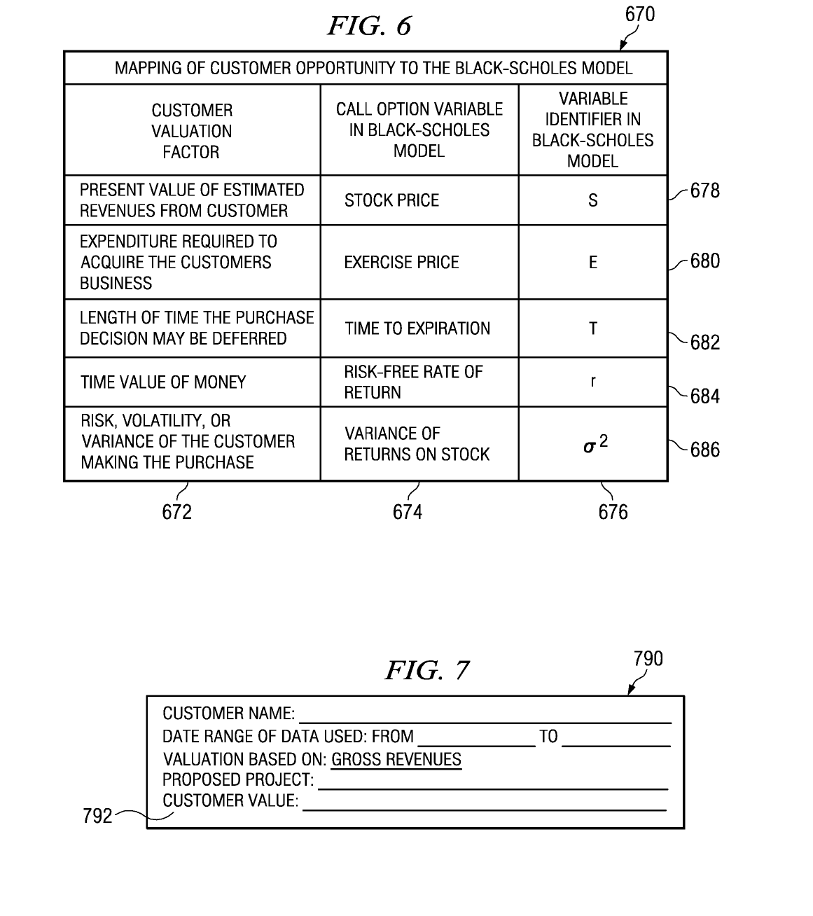

The computed value for customer variance is input into Black-Scholes model and is adapted for computing customer value and value of customer relationship projects (step 306). FIG. 6 depicts the mapping of variables in Black-Scholes model to factors in valuing a customer or a customer relationship project.

Next, the process generates a value report containing information related to the value of a specific customer and customer relationship project in question (step 308). The process terminates thereafter.

With reference now to FIG. 4, a block diagram of exemplary customer data is depicted in accordance with an illustrative embodiment. Customer data 450 includes information about transactions with one or more customers. Purchase history 452 of a customer includes value of purchases made by the customer over a period, products and services purchased by the customer, gross revenues from the customer, and net profits from the customer. Other data about a customer's purchase history can be added to customer data 450. If some prior experience with the customer is also available, estimates for future purchases based on that experience can also be a part of customer data.

Customer management history 454 contains information about the relationship with a customer. Such information includes length of time the customer has taken in the past to make a purchase decision, and the duration of engagements with the customer. Other data about a customer's management history can be added to customer management history 454.

Customer information 456 contains descriptive information about a customer. Such information includes the customer's industry and contact information. Other data about the customer can be added to customer information 456.

Additionally, any other information about customers that is relevant to business engagements with those customers can be similarly stored in customer data 450. Information about customers is highly dependent on the nature of the industry, products and services sold, and systems used for maintaining such information.

FIG. 4 shows only a few pieces of information about the customers that is relevant for the illustrative embodiments. The depicted pieces of information are not intended to be limiting on the illustrative embodiments. Furthermore, customer data can be stored in the form of flat files, encrypted files, a database, or any other form suitable for the particular system used for such storage.

With reference now to FIG. 5, two graphical representations and an equation representation of variance is depicted in accordance with an illustrative embodiment. When variance in a given distribution is high, a graph plotted for that variance is spread out. Graph 562 shows a graph of high variance as an example. Conversely, when variance in a given distribution is low, the graph for that variance has a pronounced peak in the bell curve. Graph 564 shows a graph of low variance as an example. Variance can be computed using a variety of methods, including the raw score method. Equation 566 shows how variance can be computed using the raw score method, where X represents each value of the variable in the distribution, and N is the frequency or the number of values in the distribution. σ² represents the computed variance.

With reference now to FIG. 6, a table of mapping of variables is depicted in accordance with an illustrative embodiment. Table 670 provides a mapping from the Black-Scholes model variables to the factors in valuing a customer or a customer relationship project. Column 672 labeled “customer valuation factor” lists the factors in valuing customers according to the illustrative embodiments. Column 674 labeled “call option variable in Black-Scholes model” lists the variables used in the Black-Scholes model as applied in computing stock option value. Column 676 labeled “variable identifier in Black-Scholes model” lists the identifiers used in the Black-Scholes model equation.

Row 678 describes the mapping of the variable “S” in Black-Scholes model. As applied in valuing stock options, S represents the stock price. In valuing customers, S represents the present value of estimated revenues from a customer.

Row 680 describes the mapping of the variable “E” in Black-Scholes model. As applied in valuing stock options, E represents the exercise price. In valuing customers, E represents the expenditure required to acquire the customer's business. Resources that a company must spend for getting the customer's business, or an order from the customer, are collectively the expenditure required of the company. Expenditure may include tangible resources such as money, facilities, supplies, and equipment. Expenditure may also include intangible resources such as time and effort of the sales staff spent in pursuing the customer's business. An order from a customer is a purchase requisition from the customer to the company for products or services that the company sells. Orders are generally made by customers following a purchase decision, that is, a decision by the customer to purchase the needed products or services from the company selling them.

Row 682 describes the mapping of the variable “T” in Black-Scholes model. As applied in valuing stock options, T represents the time until option expiration. In valuing customers, T represents the length of time the purchase decision may be deferred.

Row 684 describes the mapping of the variable “r” in Black-Scholes model. As applied in valuing stock options, r represents the risk free rate of return. In valuing customers, r represents the time value of money. Time value of money refers to the value of the expenditure being made by the company if the expenditure is invested in a risk free manner, such as an interest bearing bank account, instead of spending on the risky pursuit of the customer's business.

Row 686 describes the mapping of the variable “σ²” in Black-Scholes model. As applied in valuing stock options, σ² represents the variance of the returns on stock. In valuing customers, σ² represents the risk, volatility, or variance of the customer making the purchase.

Following examples illustrate the details of the computation of customer value based on the mapping depicted in FIG. 6. Assume that a company is dealing with a potential customer. The company's representatives speak to the potential customer and invest time and materials worth $1100 to sell certain services for 1 year. The customer agrees to buy the services for 1 year at a price of $1000. The net present value (NPV) of the sale is, therefore, negative $100.

NPV=−1100+1000=−100

This net present value will be referred to as the net present value of phase 1. Continuing with this example, phase 2 of this customer relationship relates to sales in the next year.

At the end of the first year, assume that the customer again has the ability to decide to buy or not buy the service for the next year. Further, assume that during the first year, the company's cost for the same time and materials, as were expended by the company's representatives before, has increased from $1100 to $1500. If the customer decides to buy the same services for another year, the company will have to invest another $1500. Also, assume that with an increase in the price of the same services, the value of expected income from the customer in the second year will be $1250. However, this value of customer's business could range from $0, if the customer decides not to buy for the second year, to $2500, if the customer buys the services for two years instead of one. The value of the customer's business ranges from $0 to $2500 and therefore has high volatility.

Variance is a measure of volatility. Such as, in this example, if the range of decision is the full range of $0-$2500, the volatility is 100 percent. If the customer relationship is 100 percent volatile, the corresponding variance is the maximum variance of 1. 100 percent volatility refers to total volatility, which in turn means that the value of the thing being measured can be anywhere within the full range of values. If a variance of 100 percent or 1 is used, the Black-Scholes model adapted for determining value of the customer, works as follows:

$$\begin{matrix}Risk free rate = r \\ = 5 \% \\ = 0.05\end{matrix}$$

$$t = 1 year$$

$$E = 1500$$

$$S = 1250$$

$$N ( {d}_{1} ) = 0.6434$$

$$N ( {d}_{2} ) = 0.263 , \\ r = 0.05$$

$$\begin{matrix}C = S [ N ( {d}_{1} ) ] - {Ee}^{- rt} [ N ( {d}_{2} ) ] \\ = 804.30 - 676.09 \\ = 428.205\end{matrix}$$

Where C is the call value in Black-Scholes model.

Therefore, the call value of phase 2 is 428.205.

Where d₁=[ln(S/E)+(r+1/2σ²)t]/√ρ²t

d₂=d1−√σ²t
N(d₁)=Probability that a standardized, normally distributed random variable will be less than or equal to d₁
N(d₂)=Probability that a standardized, normally distributed random variable will be less than or equal to d₂

Therefore, when the variance is 1, the total net present value of the relationship with the customer is the sum of net present value of phase 1 and the call value of phase 2.

Total NPV=−100+428.205=328.204

If the volatility is reduced to 50 percent, the variance reduces to 0.5, the total net present value of the customer relationship based on the above computation reduces to

−100+184.792=84.792

The above example is just a sample of how a customer value can be determined using the adapted Black-Scholes model. Each customer is considered an “investment opportunity” for the purpose of fitting into the Black-Scholes model.

In the above example, the variance has been assumed to have certain values. In practical application, the estimated variance is a management determination and can be fixed in a number of ways. For example, the variance may be based on an educated guess, the customer's purchase history, or the sales history of certain products and services. The variance may also be calculated by plotting the count of the customers who have resulted in revenue and profits on the x-axis of a graph, and the actual revenue or profits on the y-axis of the graph. This would be a normalized curve, the variance of which can then be calculated using established mathematical principles. Several other ways of determining the variance will become apparent to those of ordinary skill in the art from this disclosure.

With reference now to FIG. 7, a sample value report is depicted in accordance with an illustrative embodiment. Report 790 shows pieces of information including customer value 792, that may be relevant for making decisions based on the report. Report 790 is only an exemplary illustration of a value report. Those of ordinary skill in the art will be able to modify the depicted value report to fit a particular need from this disclosure. Using Black-Scholes model from the financial investments industry, the illustrative embodiments regard a customer as an investment opportunity for determining the value of customers and customer relationships. Illustrative embodiments can be used as a tool for evaluating and segmenting each customer in the process of developing a customer strategy. The illustrative embodiments bring attention to the value of a potential customer, the sales timeline, and the cost of the business relationship with the customer. These business metrics help a company in identifying the kind of customers it wants, the type of customer relationship desired, and thus the profitability of the relationship to the company.

Illustrative embodiments can also be used for pricing on-demand purchase of computing power. Such demand can occur when a customer sees a brief potential need for large computing power for a brief period. For example, the Wimbledon website may need to cater to increased bandwidth for a couple of weeks during the Wimbledon matches, or an online-retailer may want increased capacity starting from October through December for the holiday season. In such cases, the value of a customer can be assessed to help in pricing the on-demand computing power that will be needed.

Another use of the illustrative embodiments can be in the development of marketing and advertising budgets. The usage of Black-Scholes model in illustrative embodiments can be applied to determine which kind of customers, and how many of them, have to be reached so that appropriate budgets can be assigned for those marketing and advertising campaigns. For example, illustrative embodiments can utilize data about customers who click on an Internet based advertisement presented by a company before buying the company's product. Based on this data, including the revenue and variance of this customer segment, value of Internet advertising campaign can be determined. This value in turn can help determine appropriate marketing and advertising budgets for future advertising campaigns. Applications, such as the one described in this example, can also be useful to online search engines for pricing Internet advertisements.

Another use of the illustrative embodiments is to assign an expected monetary value to the business being conducted with each customer. By segmentation and assigning differing values, a customer is evaluated differently and is assigned a different monetary value. This can help in future business decisions about which products and services to offer or not offer to those customers, and at what price.

Another use of illustrative embodiments is in valuing certain projects and in making certain business decisions. For example, suppose the goal of a certain project is to increase the number of customers in a certain customer segment by 10,000. Assume that the value of each customer is $200. The total value will be $200*10,000=$2,000,000. Therefore, a project with these goals and costs may be profitable only if the project costs are below $2,000,000. Thus, calculating the Real Options option value, which reflects the value of a customer, can help in making spending decisions for a project and in determining the project's viability.

Another usefulness of the illustrative embodiments is in identifying the changes that are necessary on a corporate level to achieve the company's goals. For example, a large number of customer relationship management (CRM) projects fail because many companies fail to make necessary changes to their processes to achieve their strategic CRM goals. The exercise price, variable E in Black-Scholes model, indicates the cost of the business process. Lowering that cost implies the need to make changes within the company to reduce the cost. The variance is a proxy of how the company is handling its customers. High variance can be an indication of either a wrong customer segment, or bad customer service. Therefore, whether the company's business activities are suitable for a particular customer segment can be evaluated. Thus, the illustrative embodiments can produce information useful in strategic decision-making at the corporate level.

Furthermore, using the illustrative embodiments, quantification of customer value can be done more often, or as and when certain transactions are completed. This dynamic evaluation of customers and customer relationship projects can provide insights into planning for future growth, budgeting, and resource allocation for specific customers as well as for the overall management planning.

The illustrative embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the illustrative embodiments has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for valuing a customer relationship, the computer implemented method comprising:
determining a customer variance of a customer making a purchase for the customer relationship based on data about a plurality of customers to form a determined customer variance;
identifying a present value of estimated revenues from the customer, an expenditure in acquiring an order from the customer, a length of time during which a purchase decision for the order may be deferred by the customer, and a time-value of money to form inputs; and
applying the inputs and the determined customer variance to a Black-Scholes model to generate a value for the customer relationship, wherein the value of the customer relationship forms an input to a customer relationship management system used for managing the customer.

2. The computer implemented method of claim 1, wherein the Black-Scholes model is used in a Real Options computation.

3. The computer implemented method of claim 1, wherein the applying step comprises:
replacing a stock price parameter in the Black-Scholes model with the present value of estimated revenues from a customer, an exercise price parameter in the Black-Scholes model with the expenditure in acquiring the customer's business, a time to expiration parameter in the Black-Scholes model with the length of time a purchase decision may be deferred by the customer, and a risk-free rate of return parameter in the Black-Scholes model with the time-value of money, and a variance of returns on a stock parameter in the Black-Scholes model with the determined customer variance to form an adapted Black-Scholes model; and
computing the value of the customer relationship using the adapted Black-Scholes model.

4. The computer implemented method of claim 1, wherein the customer relationship is for one of work done for the customer, and amount of business contemplated from the customer.

5. The computer implemented method of claim 1, wherein the valuing the customer relationship is valuing a customer, and the value of the customer relationship is a value of the customer.

6. The computer implemented method of claim 1, wherein the determined customer variance is computed based on a plurality of number of customers making purchases and a plurality of value of the purchase.

7. The computer implemented method of claim 1, wherein the value of the customer relationship is one of displayed, printed, communicated, and stored.

8. The computer implemented method of claim 1, wherein the managing the customer comprises:
determining at least one of products to offer for sale to the customer, services to offer for sale to the customer, pricing of the products and the services, expenditures allowed for the customer relationship, viability of the customer relationship, dynamic evaluation of the customer relationship, marketing and advertising budget, and suitability of business activities.

9. A computer usable program product comprising a computer usable medium including computer usable code for valuing a customer relationship, the computer implemented method comprising:
computer usable code for determining a customer variance of a customer making a purchase for the customer relationship based on data about a plurality of customers to form a determined customer variance;
computer usable code for identifying a present value of estimated revenues from the customer, an expenditure in acquiring an order from the customer, a length of time during which a purchase decision for the order may be deferred by the customer, and a time-value of money to form inputs; and
computer usable code for applying the inputs and the determined customer variance to a Black-Scholes model to generate a value for the customer relationship, wherein the value of the customer relationship forms an input to a customer relationship management system used for managing the customer.

10. The computer usable program product of claim 9, wherein the Black-Scholes model is used in a Real Options computation.

11. The computer usable program product of claim 9, wherein the computer usable code for the applying step comprises:
computer usable code for replacing a stock price parameter in the Black-Scholes model with the present value of estimated revenues from a customer, an exercise price parameter in the Black-Scholes model with the expenditure in acquiring the customer's business, a time to expiration parameter in the Black-Scholes model with the length of time a purchase decision may be deferred by the customer, and a risk-free rate of return parameter in the Black-Scholes model with the time-value of money, and a variance of returns on a stock parameter in the Black-Scholes model with the determined customer variance, to form an adapted Black-Scholes model; and
computer usable code for computing the value of the customer relationship using the adapted Black-Scholes model.

12. The computer usable program product of claim 9, wherein the customer relationship is for one of work done for the customer, and amount of business contemplated from the customer.

13. The computer usable program product of claim 9, wherein the valuing the customer relationship is valuing a customer, and the value of the customer relationship is a value of the customer.

14. The computer usable program product of claim 9, wherein the determined customer variance is computed based on a plurality of number of customers making purchases and a plurality of value of the purchase.

15. The computer usable program product of claim 9, wherein the value of the customer relationship is one of displayed, printed, communicated, and stored.

16. The computer usable program product of claim 9, wherein the managing the customer comprises:
determining at least one of products to offer for sale to the customer, services to offer for sale to the customer, pricing of the products and the services, expenditures allowed for the customer relationship, viability of the customer relationship, dynamic evaluation of the customer relationship, marketing and advertising budget, and suitability of business activities.

17. A data processing system for valuing a customer relationship, comprising:
a storage device, wherein the storage device stores computer usable program code; and
a processor, wherein the processor executes the computer usable program code, wherein the computer usable program code comprise:
computer usable program code for determining a customer variance of a customer making a purchase for the customer relationship based on data about a plurality of customers to form a determined customer variance;
computer usable program code for identifying a present value of estimated revenues from the customer, an expenditure in acquiring an order from the customer, a length of time during which a purchase decision for the order may be deferred by the customer, and a time-value of money to form inputs; and
computer usable program code for applying the inputs and the determined customer variance to a Black-Scholes model to generate a value for the customer relationship, wherein the value of the customer relationship forms an input to a customer relationship management system used for managing the customer.

18. The data processing system of claim 17, wherein the computer usable code for the applying step comprises:
computer usable program code for replacing a stock price parameter in the Black-Scholes model with the present value of estimated revenues from a customer, an exercise price parameter in the Black-Scholes model with the expenditure in acquiring the customer's business, a time to expiration parameter in the Black-Scholes model with the length of time a purchase decision may be deferred by the customer, and a risk-free rate of return parameter in the Black-Scholes model with the time-value of money, and a variance of returns on a stock parameter in the Black-Scholes model with the determined customer variance, to form an adapted Black-Scholes model; and
computer usable program code for computing the value of the customer relationship using the adapted Black-Scholes model.

19. The data processing system of claim 17, wherein the determined customer variance is computed based on a plurality of number of customers making purchases and a plurality of value of the purchase.

20. The data processing system of claim 17, wherein the managing the customer comprises:
determining at least one of products to offer for sale to the customer, services to offer for sale to the customer, pricing of the products and the services, expenditures allowed for the customer relationship, viability of the customer relationship, dynamic evaluation of the customer relationship, marketing and advertising budget, and suitability of business activities.
